(19) United States
(12) Patent Application Publication
(10) Pub. No.: US 2020/0217446 A1
(43) Pub. Date: Jul. 9, 2020

(54) SHIMS AND METHODS OF USING

(71) Applicant: Universal Shim LLC, Valparaiso, IN (US)

(72) Inventors: Dennis J. Seramur, Valparaiso, IN (US); Jason Robert Seramur, Valparaiso, IN (US)

(21) Appl. No.: 16/825,795

(22) Filed: Mar. 20, 2020

Related U.S. Application Data
(60) Provisional application No. 62/280,921, filed on Jan. 20, 2016.

(51) Int. Cl. F16M 7/00

(52) U.S. Cl. CPC F16M 7/00; E06B 1/6069

(57) ABSTRACT

Shims with slots sized and configured to receive fasteners having different dimensions, and methods of using the shims. Such a shim includes a base region and leg portions that extend from the base region, are spaced apart from each other, are laterally separated by a longitudinal axis of the shim, and define a slot therebetween. The slot is defined by longitudinally extending side edges, inner tapered edges that are contiguous with the side edges, and an arcuate inner edge that connects and is contiguous with each of the inner tapered edges. The side edges, inner tapered edges, the arcuate inner edge define a continuous edge that surrounds and defines the slot and is defined by the base region and the leg portions. The slot has a decreasing width between the inner tapered edges in a direction along the longitudinal axis toward the arcuate inner edge.

### CROSS-REFERENCE TO RELATED APPLICATIONS

This application claims the benefit of U.S. Provisional Application No. 62/820,921, filed Mar. 20, 2019, the contents of which are incorporated herein by reference.

### BACKGROUND OF THE INVENTION

The present invention generally relates to slotted shims. The invention particularly relates to slotted shims having a slot configured to receive fasteners of various and specific dimensions.

Shims are used to align, balance, and level structures, machinery, and equipment (hereinafter, collectively referred to as equipment for convenience) used in a wide variety of domestic, commercial and industrial settings. As nonlimiting examples, in fields such as commercial and home construction, industrial manufacturing, mills, and the like, it is often necessary to level, balance, and/or align equipment such as pumps, motors, fans, adaptors, mixers, and blowers in order to promote their ability to operate without excessive vibration, cavitation, etc. Such equipment are often placed on solid foundations, such as a floor, base, or other support structure, and secured thereto with fasteners, for example, bolts that are fixed to and protrude from the foundation. Adjustments to leveling, balance, and/or alignment can be accomplished by inserting one or more shims between the base of the equipment and the foundation to adjust the spacing therebetween.

FIG. 1 schematically represents a slotted shim 110 commonly used for industrial applications. The shim 110 shown in FIG. 1 is representative of a standardized shim design known in the industry as a “Type C” shim intended for use with a limited range of fastener diameters (e.g., 0.750 to 1.1875 inches (about 19 to about 30 mm). Other shim types, including Types A, B, D, etc., are also standardized, each having a similar configuration but intended for use with a different limited range of fastener diameters (e.g., Type A for diameters of about 0.375 to 0.500 inches (about 9 to about 13 mm)), and Type B for diameters of about 0.4375 to 0.625 inches (about 11 to about 16 mm)). The shim 110 is represented in FIG. 1 as having a planar body 112 with a fastener-receiving hole or slot 114 that is continuous with one edge of the body 112 and is sized to accommodate the diameter of the threads of a fastener used to secure a piece of equipment to a foundation, such that the shim 110 contacts and supports a part of the equipment, such as a foot, pad, or other support member of the equipment, that is secured by the fastener to the foundation. An exemplary slotted shim is disclosed in U.S. Pat. No. 4,809,421 to Justice, the contents of which are incorporated herein.

Slotted shims of the type shown in FIG. 1 are generally produced with a variety of gauges (thicknesses) and slot sizes. However, the variety of shims available may lead to practical issues since each shim will have limited application. For example, each piece of equipment in a factory may have its own specific tolerances and fastener sizes. FIG. 1 schematically represents fasteners 116A, 116B, and 116C having thread diameters of different sizes. Whereas the fasteners 116A generally fit well within the slot 114 with a clearance gap therebetween as shown, the fasteners 116B are likely to be too small relative to the slot 114 to be positively and safely secure the shim 110, and the fastener 116C is too large to fit within the slot 114 without the threads of the fastener 116C interfering with the placement of the shim 110 and/or necessitating excessive force that may damage the shim 114. If a person installing a piece of equipment has shims with slots that are not the correct size for the fasteners used to secure the equipment, the person may be required to return for the proper shims resulting in a delay in the project, or may choose to proceed with using the wrong-sized shims potentially resulting in a poor quality installation and/or wasted resources.

### BRIEF DESCRIPTION OF THE INVENTION

The present invention provides shims with slots sized and configured to receive fasteners having different dimensions and methods of using the shims.

According to one aspect of the invention, a shim includes a base region and at least first and second leg portions that extend from the base region, are spaced apart from each other, and are laterally separated by a longitudinal axis of the shim. A slot is defined by and between the leg portions. The slot is defined at least in part by a pair of longitudinally extending side edges, a pair of inner tapered edges that are contiguous with the side edges, and an arcuate inner edge that connects and is contiguous with each of the inner tapered edges. The side edges, the inner tapered edges, and the arcuate inner edge define a continuous edge that surrounds and defines the slot between the leg portions and is defined by the base region and the leg portions. The slot has a decreasing width between the inner tapered edges in a direction along the longitudinal axis toward the arcuate inner edge.

According to another aspect of the invention, a method is provided for adjusting the spacing between a foundation and a foot of a piece of equipment that are secured together by a fastener. The method entails inserting a shim between the foot and the foundation such that the threaded portion of the fastener is received in the slot between the leg portions of the shim, and continuing to insert the shim between the foot and the foundation until the threaded portion of the fastener is adjacent inner tapered edges or an arcuate inner edge of the slot, and the leg portions and the base region of the shim are between the foot and the foundation.

Technical effects of the shims described above preferably include the ability to use a single size shim for a wide variety of applications, including applications that would otherwise require multiple types of shims for use with fasteners of different dimensions. As a nonlimiting example, a shim as described above may be acceptably used with a range of fastener diameters that would otherwise require the combined use two or more shim types, such as standardized shim Types A, B, and C. Consequently, an operator may be able to carry a single shim kit instead of two or three different-sized shim kits, which can weigh twice as much as a single shim kit containing the shims described herein.

Other aspects and advantages of this invention will be appreciated from the following detailed description.

### BRIEF DESCRIPTION OF THE DRAWINGS

FIG. 1 schematically represents a plan view of a conventional slotted shim.

FIG. 2 schematically represents a plan view of a slotted shim in accordance with a nonlimiting embodiment of the invention.

FIG. 3 schematically represents the shim of FIG. 2 in combination with fasteners having different thread diameters and correspondingly-sized feet of equipment.

### DETAILED DESCRIPTION OF THE INVENTION

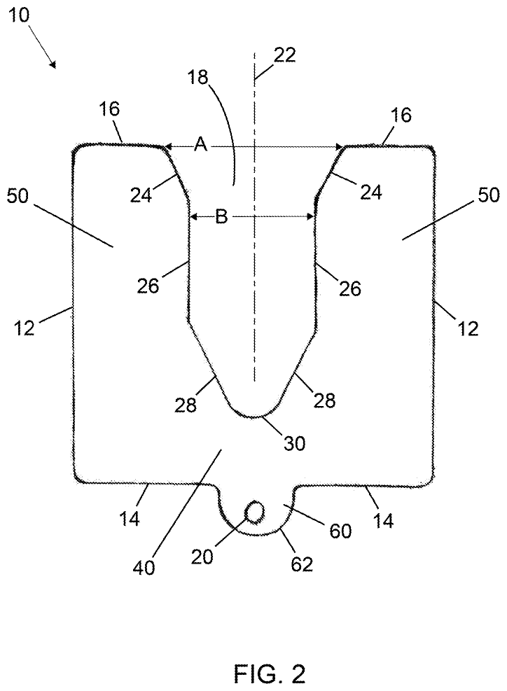

FIG. 2 represents a nonlimiting embodiment of a slotted shim 10 manufactured to have a one-piece integral construction in accordance with certain aspects of the invention. To facilitate the description provided below of the embodiment represented in the drawing, relative terms, including but not limited to, “top,” “bottom,” “upper,” “lower,” “front,” “rear,” “side,” “forward,” “rearward,” “above,” “below,” etc., may be used in reference to the orientation of the shim 10 during its use as well as the perspective of an operator during a typical installation of the shim 10 between two bodies, and therefore are relative terms that are useful to describe installations of the shim 10 represented in the drawing, but should not be necessarily interpreted as limiting the scope of the invention.

The shim 10 includes a base region 40, a pair of leg portions 50 extending from the base region 40, and a tab portion 60 that extends in a direction opposite the leg portions 50 from an outer rear edge 14 of the base region 40. Opposite side edges 12 of the shim 10, each formed by contiguous portions of the base region 40 and one of the leg portions 50, are represented as being substantially straight and parallel to one another. The tab portion 60 is generally semi-circular, centrally or axially disposed along the rear edge 14 of the shim 10, includes a curved outer edge 62, and optionally included a through-hole 20.

Opposing surfaces of the shim 10 (one of which is visible in FIG. 2) are preferably flat, planar, and parallel to each other, such that the thickness of the shim 10, including its base region 40 and leg portions 50, is generally uniform within an acceptable tolerance for the intended use. Typical but nonlimiting thicknesses for the shim 10 range from about 0.002 inch to about 0.125 inch (about 0.05 to about 3.2 mm). The shim 10 has what may be referred to as a longitudinal axis 22 that extends between the rear edge 14 of the shim 10 (defined by the base region 40) and front edges 16 of the shim 10 (defined by the leg portions 50). In the nonlimiting embodiment shown, the side edges 12 are substantially parallel to the longitudinal axis 22 and the rear and front edges 14 and 16 are substantially perpendicular to the longitudinal axis 22.

The leg portions 50 are parallel to each other, extend longitudinally from the base region 40 so as to be roughly parallel to the longitudinal axis 22, and are laterally separated from the axis 22 and spaced laterally apart from each other to define a slot 18 therebetween. The slot 18 is defined by a pair of outer tapered edges 24 that are contiguous with the front edges 16, a pair of longitudinally extending side edges 26 that are contiguous with the outer tapered edges 24, a pair of inner tapered edges 28 that are contiguous with the side edges 26, and a semi-circular or otherwise arcuate inner edge 30 that connects and is contiguous with each of the inner tapered edges 28. Together, the outer tapered edges 24, side edges 26, inner tapered edges 28, and arcuate inner edge 30 define a continuous edge or border that surrounds and defines the slot 18 between the leg portions 50, and are defined by the base region 40 and leg portions 50.

The outer tapered edges 24 define an entrance to the slot 18 between the front edges 16 of the shim 10 that defines an outer slot width of dimension “A.” In the nonlimiting embodiment shown, the outer tapered edges 24 are straight to define a uniformly decreasing slot width until the side edges 26 are encountered. The side edges 26 of the slot 18, which interconnect the outer and inner tapered edges 24 and 28, are substantially parallel to the longitudinal axis 22 to define a generally uniform or constant central slot width of dimension “B” therebetween. In the nonlimiting embodiment shown, the inner tapered edges 28 are straight to define a uniformly decreasing slot width until the arcuate inner edge 30 is encountered, with which the inner tapered edges 28 intersect so that they do not form corners with the arcuate inner edge 30. The angles of the outer tapered edges 24 relative to the longitudinal axis 22 are preferably the same, as are the angles of the inner tapered edges 28 relative to the longitudinal axis 22. In FIG. 2, the angles of the outer and inner tapered edges 24 and 28 to the longitudinal axis 22 are represented as approximately the same, in this case, approximately 27 degrees, though lesser and greater angles are foreseeable, for example, angles of about 20 to 35 degrees. The depth or length of the slot 18 may be, for example, about 2.75 inches from the front edges 16 to the base of the arcuate inner edge 30. In some embodiments, the portion of the slot 18 defined by the side edges 26 may define over half of the total depth of the slot 18, and the portion of the slot 18 defined by the inner tapered edges 28 may define roughly or at least one-fourth of the total depth of the slot 18. The arcuate inner edge 30 has a predefined radius based on the size of fasteners with which the shim 10 is to be used. For example, the radius may be roughly the same as or larger than the radius of the smallest fastener with which the shim 10 is intended to be used. To accommodate a desirable range of fastener sizes, the arcuate inner edge 30 preferably has a radius of 15 to 25% of the width “B” of the slot 18 between the side edges 26, for example, about 20% of the width “B.”

As a nonlimiting example, use of the shim 10 will hereinafter be described in reference to its installation between a lower extremity (for example, a base, foot, pad, or other support member) of a piece of equipment and a foundation on which the equipment is being installed for the purpose of adjusting the spacing therebetween to effect adjustments to the levelness, balance, and/or alignment of the equipment. However, it should be understood that the shim 10 could be used for other applications. In this example, the shim 10 will be described as placed between a foot of a piece of equipment that is intended to be secured to a foundation with fasteners, for example, bolts.

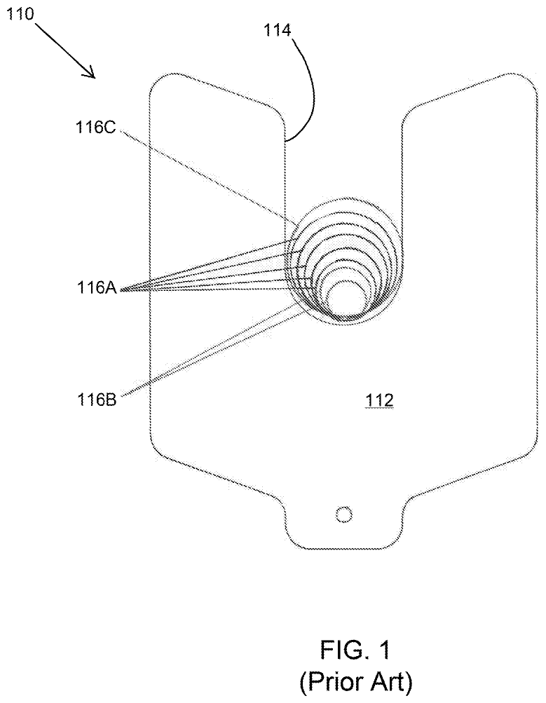

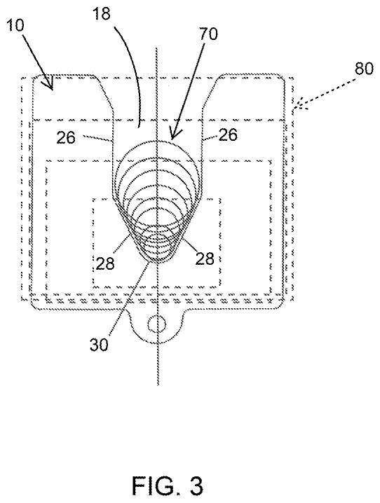

In general, slotted shims are inserted between the feet of a piece of equipment and the foundation on which the equipment is being installed until the threaded portion of one of the fasteners used to secure the equipment is adjacent but does not contact an inner edge of the shim's slot. Threads of fasteners with which the shims can be used must have a diameter that is not greater than the width of the slot. For conventional slotted shims of the type shown in FIG. 1 and configured to mate with fasteners of a specific and limited range of diameters, the shim 110 is inserted until the fastener (e.g., 116A) is adjacent but does not contact the edge of the slot 114 farthest from the slot entrance. However, the shim 10 disclosed herein includes the inner tapered edges 28, which provide the capability of receiving fasteners having different sizes by providing a gradually tapering width that terminates at the arcuate inner edge 30 of the slot 18 located farthest from the slot entrance, as illustrated in FIG. 3. As such, the location within the slot 18 at which the threaded portion of a fastener is adjacent but does not contact the edges of the slot 18 will vary depending on the diameter of the threads. In the nonlimiting examples represented in FIG. 3, the fastener 70 with the threads having the largest diameter is adjacent the inner tapered edges 28 at a location near their intersection the side edges 26 of the slot 18, whereas the fastener 70 with the threads having the smallest diameter is largely adjacent only the arcuate inner edge 30. Consequently, FIG. 3 evidences that the shim 10 is capable of receiving any fastener 70 having a thread diameter that is not greater than the width of the slot 18 between the inner side edges 26 (i.e., dimension “B” in FIG. 2), provides two points of adjacency between the fastener 70 and edges (inner tapered edges 28) of the slot 18 if the thread diameter of the fastener 70 is greater than twice the radius of the arcuate inner edge 30, and provides a line of adjacency between the fastener 70 and an edge (arcuate inner edge 30) of the slot 18 if the thread diameter of the fastener is equal to or less than twice the radius of the arcuate inner edge 30. Providing adjacency between the shim 10 and a fastener in this manner reduces the likelihood that the shim 10 will be displaced relative to the fastener 70 once installed on the fastener 70. This stability is particularly important in the event it is necessary to install multiple shims 10.

FIG. 3 represents that, following its installation, the shim 10 supports a foot 80 of a piece of equipment so as to be capable of spacing the foot 80 apart from the foundation by a distance substantially equal to the thickness of the shim 10. FIG. 3 further shows that, after installation of the shim 10, most of the surface area of the foot 80 is preferably supported by the base region 40 and leg portions 50 of the shim 10, as may be required by regulations, industry standards, or generally accepted best practices. During and after installation, the tab portion 60 may protrude from the foot 80 to enable the shim 10 to be manual manipulated and aligned during installation, and grasped if it is later desired to replace or remove the shim 10.

Shims 10 of the type shown in FIGS. 2 and 3 may be produced in a wide variety of thicknesses (gauges) so that shims 10 capable of installation with fasteners having a given range of thread diameters (as seen in FIG. 3) can be produced to have a wide variety of slot dimensions capable of installation with fasteners having a greater range of thread diameters. As a nonlimiting example, the fastener diameters represented in FIG. 3 may cover a range of diameters of about 0.4375 to 1.250 inches (about 11 to about 32 mm), which encompasses fastener diameters that might otherwise require the use of Type A, B, and C shims. As a result, each individual shim 10 is applicable to a wider variety of installations relative to conventional slotted shims, and fewer shims 10 are required to accommodate varying degrees of shimming with a wider range of fasteners.

It should be noted that the drawings are drawn for purposes of clarity when viewed in combination with the description, and therefore are not necessarily to scale. Further, the relative dimensions of portions of the shim 10 may be varied depending on the application. For example, the inner tapered edges 28 of the shim 10 may be modified to provide a greater or lesser rate change in slot width along the longitudinal axis 22. Decreasing the length of the inner tapered edges 28 and decreasing the radius of the arcuate inner edge 30 would result in the width of the slot 18 decreasing to a smaller final width over a shorter longitudinal distance.

While the invention has been described in terms of a specific or particular embodiment, it should be apparent that alternatives could be adopted by one skilled in the art. For example, the shim 10 could differ in appearance and construction from the embodiment described herein and shown in the drawing, and various materials could be used in the fabrication of the shim 10, including but not limited to 300 Series stainless steels. Accordingly, it should be understood that the invention is not necessarily limited to any embodiment described herein. It should also be understood that the phraseology and terminology employed above are for the purpose of describing the disclosed embodiment, and do not necessarily serve as limitations to the scope of the invention. Therefore, the scope of the invention is to be limited only by the following claims.

1. A shim comprising:
a base region;
at least first and second leg portions extending from the base region, spaced apart from each other, and laterally separated by a longitudinal axis of the shim; and
a slot defined by and between the leg portions, the slot being defined at least in part by a pair of longitudinally extending side edges, a pair of inner tapered edges that are contiguous with the side edges, and an arcuate inner edge that connects and is contiguous with each of the inner tapered edges, the side edges, the inner tapered edges, and the arcuate inner edge defining a continuous edge that surrounds and defines the slot between the leg portions and is defined by the base region and the leg portions, wherein the slot has a decreasing width between the inner tapered edges in a direction along the longitudinal axis toward the arcuate inner edge.

2. The shim of claim 1, wherein the slot is further defined by a pair of outer tapered edges that are contiguous with the side edges and contiguous with outer edges of the shim.

3. The shim of claim 1, wherein the side edges are parallel to each other and the slot has a constant width between the side edges.

4. The shim of claim 1, wherein the leg portions are parallel to each other and to the longitudinal axis of the shim.

5. The shim of claim 1, wherein the arcuate inner edge has a semi-circular shape.

6. The shim of claim 5, wherein the slot has a width between the side edges and the arcuate inner edge has a radius of 15 to 25% of the width of the slot. 7 The shim of claim 1, wherein the inner tapered edges are at equal angles relative to the longitudinal axis.

8. The shim of claim 1, wherein the inner tapered edges are at angles of 20 to 35 degrees relative to the longitudinal axis.

9. The shim of claim 1, wherein the slot has a depth from an outer edge of the shim to the arcuate inner edge, and a portion of the slot defined by the side edges defines over half of the depth of the slot.

10. The shim of claim 1, wherein the slot has a depth from an outer edge of the shim to the arcuate inner edge, and a portion of the slot defined by the inner tapered edges defines at least one-fourth of the depth of the slot.

11. A shim having front and rear ends and a longitudinal axis extending therebetween, the shim comprising:
a base region;
a pair of leg portions integral with the base region, the leg portions being parallel to each other, parallel to the longitudinal axis of the shim, and extending from the base toward the front end of the shim, the leg portions defining therebetween a slot extending from the front end to the base region of the shim, the slot being defined a pair of outer tapered edges that are contiguous with the front edge of the shim, a pair of longitudinally extending side edges that are parallel to each other and contiguous with the outer tapered edges, a pair of inner tapered edges that are contiguous with the side edges, and an arcuate inner edge that connects and is contiguous with each of the inner tapered edges, the outer tapered edges, the side edges, the inner tapered edges, and the arcuate inner edge defining a continuous edge that surrounds and defines the slot between the leg portions and are defined by the base region and the leg portions, wherein the slot has a constant width between the side edges and a decreasing width between the inner tapered edges in a direction along the longitudinal axis toward the arcuate inner edge;
wherein the base region and the leg portions have a constant thickness and the slot accommodates a fastener having a diameter ranging from twice a radius of the arcuate inner edge to less than the constant width.

12. The shim of claim 11, wherein the arcuate inner edge has a semi-circular shape.

13. The shim of claim 12, wherein the arcuate inner edge has a radius of 15 to 25% of the constant width of the slot. 14 The shim of claim 11, wherein the inner tapered edges are at equal angles relative to the longitudinal axis.

15. The shim of claim 11, wherein the inner tapered edges are at angles of 20 to 35 degrees relative to the longitudinal axis.

16. The shim of claim 11, wherein the slot has a depth from the front edge of the shim to the arcuate inner edge, a first portion of the slot defined by the side edges defines over half of the depth of the slot, and a second portion of the slot defined by the inner tapered edges defines at least one-fourth of the depth of the slot.

17. A method of adjusting the spacing between a foundation and a foot of a piece of equipment using the shim of claim 1, wherein the foot and the foundation are secured together by a fastener having a threaded portion, the method comprising:
inserting the shim between the foot and the foundation such that the threaded portion of the fastener is received in the slot between the leg portions; and
continuing to insert the shim between the foot and the foundation until the threaded portion of the fastener is adjacent the inner tapered edges or the arcuate inner edge of the slot, and the leg portions and the base region of the shim are between the foot and the foundation.

18. The method of claim 17, wherein the threaded portion of the fastener is adjacent only the inner tapered edges of the slot.

19. The method of claim 17, wherein the threaded portion of the fastener is adjacent only the arcuate inner edge of the slot.
